(19) United States
(12) Patent Application Publication
(10) Pub. No.: US 2023/0177105 A1
(43) Pub. Date: Jun. 8, 2023

(54) METHOD AND COMPUTER PROGRAM PRODUCT FOR DETERMINING THE MEASUREMENT UNCERTAINTY OF A MEASURING SYSTEM

(71) Applicant: Kistler Holding AG, Winterthur (CH)

(72) Inventors: MARC SCHAAD, Unterentfelden (CH); GEORG SCHADING, Ehrendingen (CH); MARCO ANGLIKER, Zürich (CH); VIOLA EHRENSPERGER, Henggart (CH)

(21) Appl. No.: 18/162,045

(22) Filed: Jan. 31, 2023

Related U.S. Application Data
(62) Division of application No. 16/767,958, filed on May 28, 2020.

(30) Foreign Application Priority Data
Nov. 30, 2017 (EP) 17204558.5

(51) Int. Cl. G06F 17/11

(52) U.S. Cl. CPC G06F 17/11; G01D 2218/10

(57) ABSTRACT

A method for determining the measurement uncertainty of a measuring system that detects a physical measurement variable includes a plurality of transmission links forming a measuring chain for detecting a physical measurement quantity. Directly adjacent transmission links are in a cause-and-effect relationship in the measuring chain. The method includes using a computer program to read in information for identifying the transmission links; reading in legible labels of influencing variables of the transmission links identified by the computer program product; determining a relevance of the influencing variables of the identified transmission links for the computer program's measurement uncertainty; and using influencing variables determined as being relevant for calculating the computer program's measurement uncertainty.

### CROSS REFERENCE TO RELATED APPLICATIONS

This application is a divisional of copending International Application No. 16/767,958, filed May 28, 2020, which is hereby incorporated herein by this reference in its entirety for all purposes.

### FIELD OF THE INVENTION

The invention relates to a method and computer program product for determining the measurement uncertainty of a measuring system.

### BACKGROUND OF THE INVENTION

The detection of a physical measurement variable by means of a measuring system is well known. This physical measurement variable may be a force, a weight, a temperature, and the like. The physical measurement variable is represented as a measured value with a number and unit of measurement. The unit of measurement is usually given in a standardized form in Newtons (N), Kilograms (kg), Kelvin (K), and the like.

Generally, detecting the physical measurement variable requires several steps that are separated from each other in terms of time and space. A temperature is measured in a measuring room, for example, for which purpose a sensor disposed in the measuring room detects an electrical resistance in the form of an electrical voltage, the electrical voltage is then transmitted as the measuring signal via a signal cable to an evaluation unit that is spatially remote from the measuring room where the measuring signal is electrically amplified and represented as a measured value on a display. That means, measuring the temperature occurs before the measured value is displayed. A measuring system of this type therefore comprises a plurality of transmission links such as a sensor, measuring cable and evaluation unit which transmission links form a measuring chain. There is a cause-and-effect relationship between directly adjacent transmission links of the measuring chain for detecting the physical measurement variable.

Since the measured value always differs from the true value, the detection of the physical measurement variable is associated with a measurement uncertainty. For this reason, ISO/IEC Guide 98-3: 2008-09 requires presenting the physical measurement variable as the best approximation together with an associated coverage interval. The best approximation is an arithmetic mean of a plurality of measurements. The measurement uncertainty is the difference between upper and lower limits of the coverage interval and the best estimated value. The true value is included in the coverage interval with a predefined coverage probability.

Measurement uncertainty is a function of influencing variables of the transmission links. Each influencing variable is represented as an influence value. A best influence estimate is an arithmetic mean of several influencing variables. According to ISO/IEC Guide 98-3: 2008-09 a model-based procedure is to be carried out to determine the measurement uncertainty wherein first the influencing variables of the transmission links are determined followed by calculating a best influence estimate for each determined influencing variable as well as a measurement uncertainty contribution attributed to the best influence estimate.

Generally, a user of the measuring system wants to know the measurement uncertainty involved in detecting a physical measurement variable when using the measuring system. For example, the measuring system is part of a production facility for industrial goods. In this case, the production system is often overdesigned solely because of an unknown measurement uncertainty, or an unknown measurement uncertainty results in bad parts in the production of industrial goods. In both cases, the unknown measurement uncertainty leads to additional investment and production costs.

However, to gain knowledge on the measurement uncertainty of a measuring system a model-based procedure is required comprising the determination of the relevant influencing variables of the transmission links and calculating the best influence estimates together with the associated measurement uncertainties. The user of a measuring system often wants to avoid the time and material effort involved in such a model procedure.

### OBJECTS AND SUMMARY OF THE INVENTION

It is the object of the present invention to provide a method for determining the measurement uncertainty of a measuring system which method requires little time and material effort.

This object has been achieved by the features described below.

The present invention relates to a method for determining the measurement uncertainty of a measuring system; which measuring system detects a physical measurement variable; wherein the measuring system comprises a plurality of transmission links; which transmission links form a measuring chain for detecting the physical measurement variable, wherein directly adjacent transmission links are in a cause-and-effect relationship to one another in the measuring chain; said method comprising the steps of: a) reading in information for identifying the transmission links of the measuring chain by a computer program product; b) reading in readable labels of influencing variables of the identified transmission links by the computer program product, and determining a relevance of the influencing variables of the identified transmission links regarding the measurement uncertainty of the measuring system by the computer program product; and c) using the influencing variables determined to be relevant for calculating the measurement uncertainty of the measuring system by the computer program product.

The applicant has found that as a commercial provider of measuring systems it has sufficient expertise to help a user of an existing measuring system in determining the measurement uncertainty of their measuring system. This is because a measuring chain is often already assembled with available transmission links at the user. In this case, the transmission links are selected on the basis of their ease of availability. However, the user does not know the amount of measurement uncertainty of the measuring system.

This is where the invention comes in. In the method according to the invention the expert knowledge of the applicant is made available to the user. The transmission links of their assembled measuring chain are identified for the user and the influencing variables of the identified transmission links on the measurement uncertainty of the measuring system are determined. The measurement uncertainty of the measuring system is calculated using the determined influencing variables.

Preferably, a measurement uncertainty contribution attributed to a best influence estimate of the determined influencing variable is provided for each determined influencing variable. Then, the measurement uncertainty of the measuring system is calculated from the measurement uncertainty contributions provided. The method according to the invention requires little time and material effort of the user.

Steps a) to c) of the inventive method for determining the measurement uncertainty of a measuring system are carried out by a computer program product.

### BRIEF DESCRIPTION OF THE DRAWINGS

In the following the invention will be exemplarily illustrated referring to the Figures in which:

FIG. 1 shows a representation of a measuring system comprising a plurality of transmission links;

FIG. 2 shows a schematic diagram of steps in the method for determining the measurement uncertainty of the measuring system according to FIG. 1;

FIG. 3 shows a representation of a computer system for a computer program product for carrying out the method according to FIG. 2;

FIG. 4 shows a representation of a first embodiment of the computer system according to FIG. 3 for carrying out step a) of the method according to FIG. 2;

FIG. 5 shows a representation of a second embodiment of the computer system according to FIG. 3 for carrying out step a) of the method according to FIG. 2;

FIG. 6 shows a representation of a first exemplary embodiment of a measurement uncertainty calculated from measurement uncertainty contributions in step c) of the method according to FIG. 2;

FIG. 7 shows a representation of a second exemplary embodiment of a measurement uncertainty calculated from measurement uncertainty contributions in step c) of the method according to FIG. 2;

FIG. 8 shows a representation of an adjustment of the performance of the measuring system having the measurement uncertainty calculated in the first exemplary embodiment of the method according to FIGS. 2 and 6; and

FIG. 9 shows a representation of an adjustment of the performance of the measuring system having the measurement uncertainty calculated in the second exemplary embodiment of the method according to FIGS. 2 and 7.

### DETAILED DESCRIPTION OF EXEMPLARY EMBODIMENTS

FIG. 1 shows an exemplary embodiment of a measuring system S comprising a plurality of transmission links G1-G4. As explained in the beginning, measuring system S serves for detecting a physical measurement variable. For this purpose, the transmission links G1-G4 form a measuring chain K. There is a cause-and-effect relationship between directly adjacent transmission links G1-G4 of the measuring chain K, for example transmission links G1 and G2 or transmission links G2 and G3, for detecting the physical measurement variable. Four transmission links G1-G4 are shown in the exemplary embodiment according to FIG. 1. However, the person skilled in the art knowing the present invention may of course design a measuring system comprising more transmission links or fewer transmission links.

Transmission link G1 is a sensor such as a pressure sensor, an acceleration sensor, a temperature sensor, and the like. Accordingly, the sensor measures the physical measurement variable which is pressure, acceleration, temperature, and the like and generates an analog measuring signal such as an electric current, an electric voltage, and the like. Using a sensor in the form of a piezoelectric sensor the physical measurement variable may be measured with a measuring frequency of up to 100 kHz. Furthermore, using a piezoelectric sensor the analog measuring signal further is proportional to the physical measurement variable under normal conditions. A piezoelectric sensor is able to measure a force with a measuring sensitivity of a few pC/N. However, the measurement sensitivity changes with ambient temperature and age of the piezoelectric sensor. In addition, the analog measuring signal shows a deviation from proportionality to the physical measurement variable which is referred to as the linearity of the piezoelectric sensor. Finally, the analog measuring signal can only be reproduced with a measurement accuracy of the piezoelectric sensor. A “temperature dependence of the measurement sensitivity of the piezoelectric sensor” is a first influencing variable E11 of the transmission member G1 that is relevant for the measurement uncertainty U of the measuring system S. An “age-related variation in measurement sensitivity of the piezoelectric sensor” is a second influencing variable E12 of the transmission link G1 relevant for the measurement uncertainty U of the measuring system S. A “linearity of the piezoelectric sensor” is a third influencing variable E13 of the transmission link G1 which is relevant for the measurement uncertainty U of the measuring system S. A “reproducibility of the analog measuring signal” is a fourth influencing variable E14 of the transmission link G1 relevant for the measurement uncertainty U of the measuring system S.

Transmission link G2 is a signal cable that transmits the analog measuring signal from the sensor to an electric amplifier. In the case of piezoelectric sensors the analog measuring signal may have a measurement frequency of up to 100 kHz and may be an electric charge of a few pC. In this respect, a cable impedance of the signal cable is important. Especially when the signal cable is not terminated with a wave resistance the cable impedance changes at the input terminal of the signal cable. A “length of the signal cable” is a first influencing variable E21 of the transmission link G2 which is relevant for the measurement uncertainty U of the measuring system S. A “transmission frequency” is a second influencing variable E22 of the transmission link G2 which is relevant for the measurement uncertainty U of the measuring system S.

Transmission link G3 is the electric amplifier that receives the transmitted analog measuring signal and electrically amplifies the transmitted analog measuring signal and converts the transmitted analog measuring signal into a digital measuring signal. A “measurement accuracy of the electric amplifier” is a first influencing variable E31 of the transmission link G3 which is relevant for the measurement uncertainty U of the measuring system S. A “crosstalk between input channels of the electric amplifier” is a second influencing variable E32 of the transmission link G3 which is relevant for the measurement uncertainty U of the measuring system S.

Transmission link G4 is an evaluation unit that evaluates the digital measuring signal. The evaluation unit comprises a data processing processor, a data memory and a display screen. For evaluation, the digital measuring signal is loadable in a computer program product running on the data processing processor. The digital measuring signal may be further processed by the computer program product. The digital measuring signal may be stored in the data memory. The digital measuring signal may also be displayed on the display. A “rounding errors in further processing” is a first influencing variable E41 of the transmission link G4 relevant for the measurement uncertainty U of the measuring system S. A “speed of further processing” is a second influencing variable E42 of the transmission link G4 that is relevant for the measurement uncertainty U of the measuring system S.

However, the person skilled in the art knowing the present invention may also implement a measuring system with other transmission links and having other relevant influencing variables.

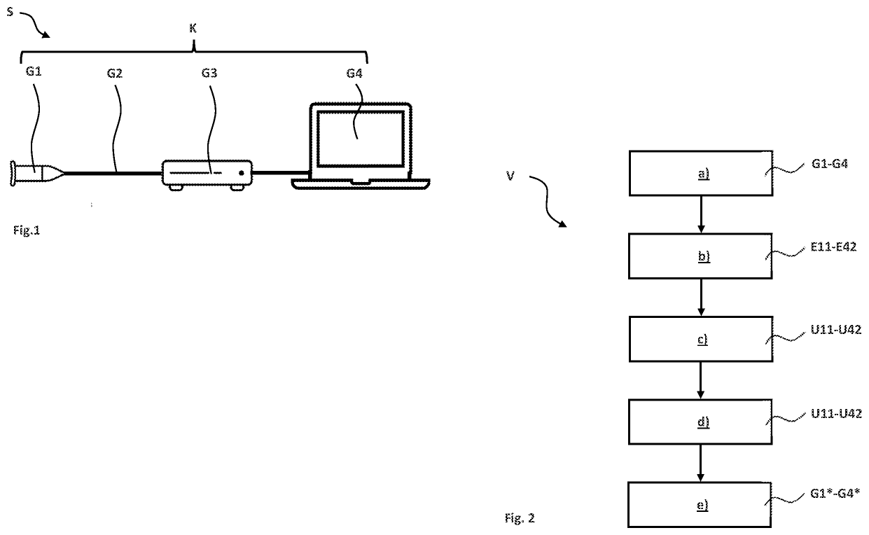

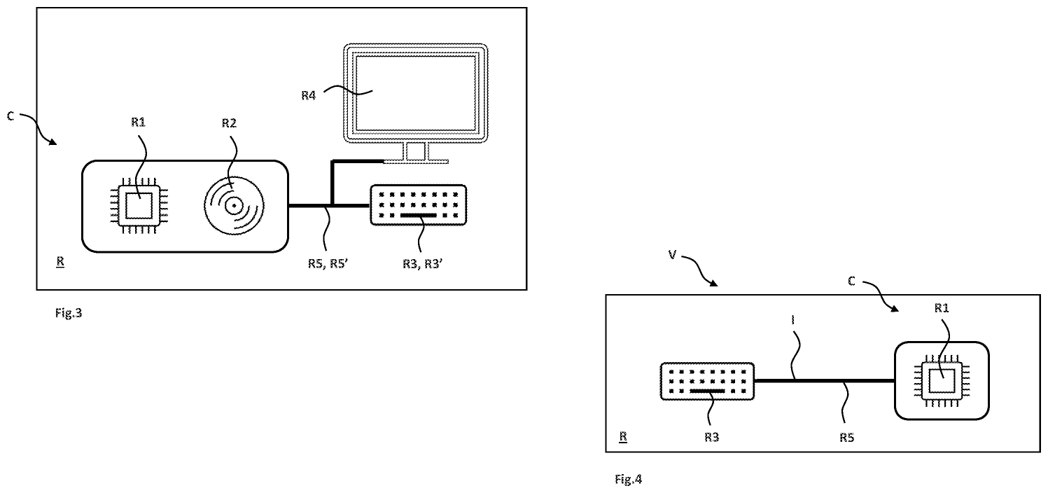

FIG. 2 is a schematic representation of steps a) to e) of the method V for determining the measurement uncertainty U of the measuring system S. Steps a) to c) are essential for the invention. The further steps d) and e) are optional. In step a), the transmission links G1-G4 of the measuring chain K are identified. In step b), influencing variables E11-E42 of the identified transmission links G1-G4 on the measurement uncertainty U of the measuring system S are determined. In step c), the influencing variables E11-E42 determined are used to calculate the measurement uncertainty U of the measuring system S. In step d), at least one identified transmission link G1-G4 having a measurement uncertainty contribution U11-U44 that differs from an average measurement uncertainty contribution U0 is determined. Furthermore in step e), at least one replacement transmission link G1*-G4* having a replacement measurement uncertainty contribution U11*-U44* is determined for the at least one identified transmission link G1-G4.

FIG. 3 shows a computer system R for a computer program product C adapted to carry out the method V for determining the measurement uncertainty U of the measuring system S. Components of the computer system R include a data processing processor R1, a data memory R2, at least one input unit R3, R3′, an output unit R4 and at least one communication unit R5, R5′. The computer system R may be a commercially available computer. The input unit R3, R3′ may be a keyboard, a mouse, a touch screen, a data interface, and the like. The output unit R4 may be a computer display, a touch screen, and the like. The communication unit R5, R5′ communicates data between components of the computer system R. Communication unit R5, R5′ may be a network such as the Internet, a computer bus such as the Peripheral Component Interconnect Express (PCIe) bus, and the like. The data interface is connected to the communication unit R5, R5′ that has the form of a network where it may communicate according to a network protocol such as the Internet Protocol (IP), the PCIe protocol, and where it is addressable with a network address.

Individual components of computer system R may be arranged in the measuring system S of the user, however, they may also be arranged at a location remote from the measuring system S of the user. For the purposes of the invention, “remote” is intended to mean at any distance apart. Furthermore, the components of computer system R may also be arranged at any distance apart from each other. Thus, only the input unit R3 and the output unit R4 may be located at the user while the data processing processor R1 and data memory R2 are located remote from the user. There may also be more than one of each of the components of computer system R. Thus, it is possible to have a first input unit R3 and a first output unit R4 arranged with the user while a second input unit R3′ is arranged remote from the user. Furthermore, it is possible for the computer system R to comprise a first communication unit R5 and a second communication unit R5′.

The computer program product C may be stored in data memory R2 and loaded from data memory R2 into data processing processor R1 where it is executable to carry out the method V for determining the measurement uncertainty U of the measuring system S. For carrying out step a), digital information data I for identifying the transmission links G1-G4 are read into computer program product C. Reading in the digital information data I from the data memory R2 is performed via the input unit R3 and the communication unit R5.

In the first embodiment of step a) according to FIG. 4, the user may enter information for identifying the transmission members G1-G4 of the measuring chain K via the input unit R3 that has the form of a computer keyboard or the user may enter information for identifying the transmission links G1-G4 of the measuring chain K via the input unit R3 that has the form of a touch screen by selecting the transmission links depicted thereon. Then, the information entered at the input unit R3 is communicated as digital information data I via communication unit R5 to the data processing processor R1 where it is read in by the computer program product C.

In the second embodiment of step a) according to FIG. 5, the user may enter information for identifying the transmission links G1-G4 of the measuring chain K via a first input unit R3 having the form of a computer keyboard or a touch screen of a computer. The computer is not depicted in FIG. 5. The first input unit R3 is connected via the computer to the first communication unit R5 that has the form of a network. Via the computer and the first communication unit R5, first input unit R3 calls the network address of the second input unit R3′ having the form of a data interface. Then, the entered information is communicated by the first input unit R3 as digital information data Ito the network address of the second input unit R3′. Via the second communication unit R5′, the digital information data I communicated to the second input unit R3′ are communicated to the data processing processor R1 where they are read in by the computer program product C.

Further referring to FIG. 5, in a third embodiment of step a) it is also possible that the computer program product C automatically reads in digital information data for identifying the transmission links G1-G4 of the measuring chain K without any user interaction. For this purpose, transmission links G1-G4 comprise at least one information carrier such as a transducer electronic data sheet (TEDS) according to Institute of Electrical and Electronics Engineers (IEEE) Standard 1451. The information carrier is not shown in FIG. 5. The information carrier is a data memory. Digital information data I of transmission links G1-G4 are stored in the information carrier. The information carrier is connected to the first communication unit R5 having the form of a network via at least one first input unit R3 that has the form of a data interface. Computer program product C is connected to the first communication unit R5 via the second input unit R3′ having the form of a data interface. Via the second input unit R3′ and the first communication unit R5, computer program product C calls the network address of the at least one first input unit R3. The information carrier called in this way then communicates the digital information data I to the network address of the second input unit R3′. The digital information data I communicated to the second input unit R3′ are communicated via the second communication unit R5′ to the data processing processor R1 where they are read in by the computer program product C.

Those skilled in the art knowing the present invention may also combine the three embodiments of step a) explained above. Thus, according to the first embodiment of step a) the user may enter information for identifying the transmission members G2-G4 via a contactless display by selecting transmission links depicted thereon while according to the third embodiment of step a) computer program product C automatically reads in digital information data for transmission link G1.

In step b), computer program product C determines influencing variables E11-E42 on the measurement uncertainty U of the measuring system S for the identified transmission links G1-G4. For this purpose, the computer program product C has access to data memory R2 storing predetermined influencing variables E11-E42 of transmission links G1-G4. A distinction is made between relevant and non-relevant influencing variables. An influencing variable is relevant if it has a significant contribution to the measurement uncertainty U of the measuring system S. Preferably, those influencing variables are relevant which contribute most to the measurement uncertainty U of the measuring system S and which have an overall contribution of at least 80% to the measuring uncertainty U of the measuring system S. The relevance of an influencing variable is predetermined. It is preferable to use only relevant influencing variables when determining the influencing variables on the measurement uncertainty U of the measuring system S. Preferably, relevant influencing variables are marked with a legible label specifying “relevant” while non-relevant influencing variables are marked with a legible label specifying “not relevant”. Computer program product C is adapted for reading the labels and determining the relevance of the influencing variables on the measurement uncertainty U of the measuring system S by identifying the information on the labels.

For each identified transmission link G1-G4, computer program product C determines at least one relevant influencing variable E11-E42 attributed to the identified transmission link G1-G4 which it retrieves from data memory R2. For the identified transmission link G1 being a piezoelectric sensor, computer program product C retrieves the relevant influencing variables E11-E14 “temperature dependence of the measurement sensitivity of the piezoelectric sensor”, “age-related variation in measurement sensitivity of the piezoelectric sensor”, “linearity of the piezoelectric sensor” and “reproducibility of the analog measuring signal” from data memory R2. For an identified transmission link G2 being a signal cable, computer program product C retrieves the relevant influencing variables E21, E22 “length of the signal cable” and “transmission frequency” from data memory R2. For an identified transmission link G3 being an electric amplifier, computer program product C retrieves the relevant influencing variables E31, E32 “measurement accuracy of the electric amplifier” and “crosstalk between input channels of the electric amplifier” from data memory R2. For an identified transmission link G4 being an evaluation unit, computer program product C retrieves the relevant influencing variables E41, E42 “rounding errors in further processing” and “speed of further processing” from data memory R2. Relevant influencing variables E11-E42 retrieved from data memory R2 are communicated via the communication unit R5 to the data processing processor R1 where they are read in by computer program product C.

Then, computer program product C uses the determined influencing variables E11-E42 in step c) for calculating the measurement uncertainty U of the measuring system S. For this purpose, data memory R2 also stores best influence estimates and measurement uncertainty contributions attributed to these best influence estimates for the predetermined influencing variables. A measurement uncertainty contribution associated with the best influence estimate of the influencing variable is provided in data memory R2 for each influencing variable. For each determined influencing variable E11-E42, computer program product C retrieves from data memory R2 a measurement uncertainty contribution U11-U42 attributed to the best influence estimate of the determined influencing variable E11-E42. Measurement uncertainty contributions U11-U42 retrieved from data memory R2 are communicated via communication unit R5 to the data processing processor R1 where they are read in by the computer program product C.

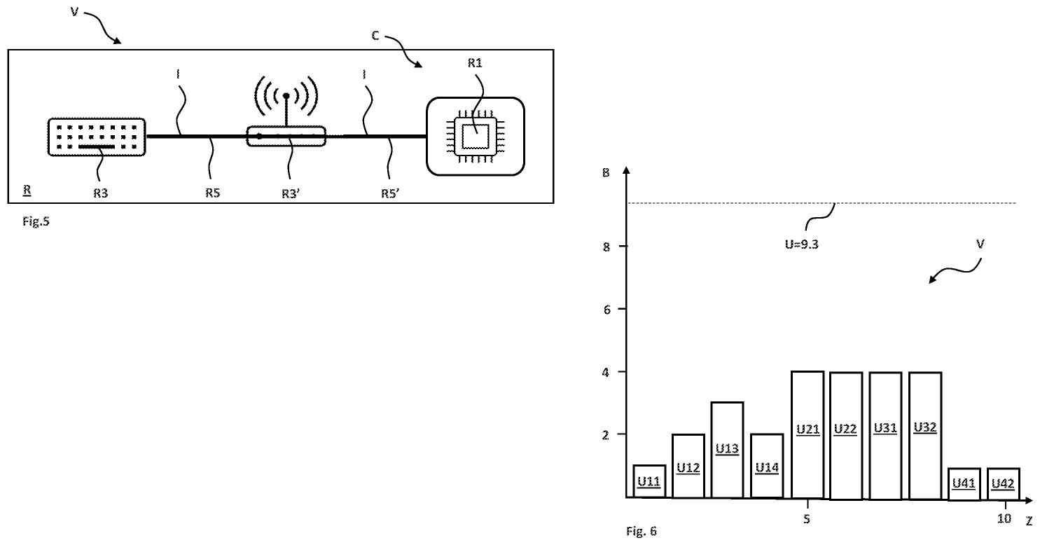

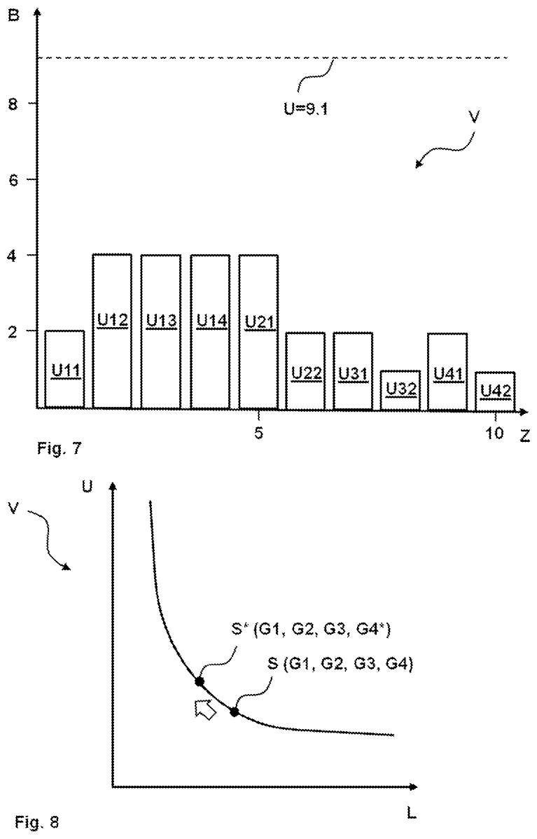

Computer program product C displays the calculated measurement uncertainty U of the measuring system S on the output unit R4. As shown in the two exemplary embodiments according to FIGS. 6 and 7, an ordinate represents an amount B of the measurement uncertainty contributions U11-U42 and an abscissa represents a number Z of measurement uncertainty contributions U11-U42. Computer program product C calculates the measurement uncertainty U of the measuring system S by summing up the squares of the measurement uncertainty contributions U11-U42 and calculating a square root of the sum.

The first exemplary embodiment according to FIG. 6 results in a measurement uncertainty U=9.3 for ten measurement uncertainty contributions U11-U42.

The second exemplary embodiment according to FIG. 7 results in a measurement uncertainty U=9.1 for ten measurement uncertainty contributions U11-U42.

Computer program product C determines in step d) at least one identified transmission link G1-G4 that has an important measurement uncertainty contribution U11-U42. For the purposes of the present invention, a measurement uncertainty contribution U11-U42 is important if it is smaller or higher than at least one of the other measurement uncertainty contributions U11-U42.

In the first exemplary embodiment according to FIG. 6 of a calculated measurement uncertainty U of a measuring system S, seven measurement uncertainty contributions U11, U21, U22, U31, U32, U41, U42 are important where the three measurement uncertainty contributions U11, U41, U42 are the smallest and the four measurement uncertainty contributions U21, U22, U31, U32 are the highest.

In the second exemplary embodiment of a calculated measurement uncertainty U of a measuring system S according to FIG. 7, six measurement uncertainty contributions U12, U13, U14, U21, U32, U42 are important where the two measurement uncertainty contributions U32, U42 are the smallest and the four measurement uncertainty contributions U12, U13, U14, U21 are the highest.

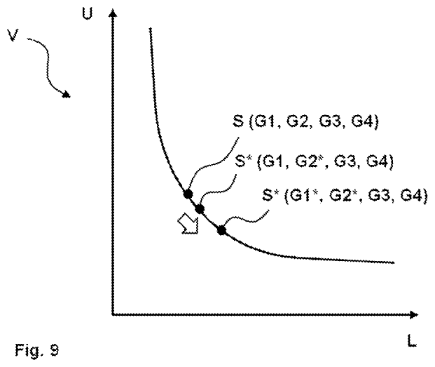

FIGS. 8 and 9 show two exemplary embodiments of a measurement uncertainty U of a measuring system S as a function of a performance L of a measuring system S. An ordinate represents the measurement uncertainty U of the measuring system S and an abscissa represents the performance L of the measuring system S. The measurement uncertainty U of the measuring system S is a multi-dimensional characteristic diagram and depends on characteristic parameters of the performance L of the measuring system S such as effectiveness, availability, number of maintenance cycles, maintenance quality, procurement price, environmental influences, and the like. The measurement uncertainty U of the measuring system S comprising transmission links G1-G4 is shown as point S (G1, G2, G3, G4).

The user to whom the measurement uncertainty U in the exemplary embodiments according to FIGS. 6 to 9 is displayed not only registers the measurement uncertainty U of the measuring system S but is also able to assess the measurement uncertainty U of the measuring system S as a function of the performance L of the measuring system S.

For the example mentioned in the beginning of a measuring system that is part of a production system for industrial goods wherein the production system is overdesigned due to an unknown measurement uncertainty, FIG. 6 shows a first exemplary embodiment of the measurement uncertainty U calculated for the measuring system S, and FIG. 8 shows a first exemplary embodiment of the calculated measurement uncertainty U as a function of the performance L of the measuring system S. The user recognizes that the measurement uncertainty contributions U41, U42 for the relevant influencing variables E41, E42 “rounding errors in further processing” and “speed of further processing” are the smallest. This finding leads to the conclusion that the particular identified transmission link G4 which is an evaluation unit is overdesigned. To save investment costs, computer program product C replaces the particular identified transmission link G4 by a replacement transmission link G4* said replacement transmission link G4* having relatively higher replacement measurement uncertainty contributions U41*, U42*.

Furthermore, for the other example mentioned in the beginning of a measuring system that is part of a production facility for industrial goods wherein the industrial goods production results in bad parts due to an unknown measurement uncertainty, FIG. 7 shows a second exemplary embodiment of the measurement uncertainty U calculated for the measuring system S, and FIG. 9 shows a second exemplary embodiment of the calculated measurement uncertainty U as a function of the performance L of the measuring system S. The user recognizes that the measurement uncertainty contributions U12-U14, U21 for the relevant influencing variables E12 “age-related variation in measurement sensitivity of the piezoelectric sensor”, E13 “linearity of the piezoelectric sensor”, E14 “reproducibility of the analog measuring signal” and E21 “length of the signal cable” are the highest. This finding then leads to the conclusion that the particular transmission links G1, G2 have higher than average measurement uncertainty contributions U12-U14, U21. To reduce the number of bad parts and, thus, production costs, computer program product C replaces at least one particular transmission link G1, G2 by a replacement transmission link G1*, G2* said replacement transmission link G1*, G2* having a relatively smaller replacement measurement uncertainty contribution U12*-U14*, U21*.

For the at least one particular identified transmission link G1-G4, computer program product C determines in step e) at least one replacement transmission link G1*-G4* having a replacement measurement uncertainty contribution U11*-U42*. For this purpose, digital information data I, I* of transmission links G1-G4, G1*-G4* are stored in data memory R2. Digital information data I, I* comprise essential technical characteristics of the transmission links G1-G4, G1*-G4*. The essential technical characteristics characterize the transmission links G1-G4, G1*-G4*. Preferably, essential technical characteristics of a large number of transmission links G1-G4, G1*-G4* are stored in data memory R2. This ensures that at least one equivalent replacement transmission link G1*-G4* is stored for a particular identified transmission link G1-G4. In the frame of the present invention, a replacement transmission link G1*-G4* is equivalent if the essential characteristics correspond to those of the particular identified transmission link G1-G4 and if it differs in only at least one measurement uncertainty contribution U11-U42 from the particular identified transmission link G1-G4.

Thus, transmission link G1 of measuring system S is a sensor and the essential technical characteristics for a sensor having the form of a piezoelectric sensor are the measuring range, the measuring sensitivity, the measuring accuracy, and the like.

Transmission links G2 of measuring system S is a signal cable. The essential technical characteristics of the signal cable are the cable impedance at the input terminal of the signal cable, the length of the signal cable, and the like.

Transmission link G3 of measuring system S is an electric amplifier. The essential features of the electric amplifier are the measuring accuracy of the electric amplifier, crosstalk between input channels of the electric amplifier, and the like.

Finally, transmission link G4 of measuring system S is an evaluation unit. The essential technical characteristics of the evaluation unit are the accuracy of further processing, the “speed of further processing, and the like.

Based on the essential technical characteristics stored in the data memory of transmission links G1-G4, G1*-G4*, computer program product C is able to find at least one replacement transmission link G1*-G4* in the data memory R2. For this purpose, computer program product C compares digital information I of the particular transmission link G1-G4 with digital information 1* stored in data memory R2 for replacement transmission links G1*-G4*. For the particular transmission link G1-G4, computer program product C determines at least one equivalent replacement transmission link G1*-G4* and retrieves digital information 1* for the replacement transmission link G1*-G4* from data memory R2.

Using the digital information 1* of replacement transmission link G1*-G4*the replacement transmission link G1*-G4* is physically provided, for example by procurement, and in measuring system S the particular transmission link G1-G4 is replaced by the thus physically provided replacement transmission link G1*-G4*.

In the first exemplary embodiment according to FIG. 8, measuring system S (G1, G2, G3, G4) is replaced by replacement transmission link G4* thus forming a replacement measuring system S* (G1, G2, G3, G4*). Because the replacement measurement uncertainty contributions U41*-U44* are relatively higher, the measurement uncertainty U of replacement measuring system S* is increased. In FIG. 8, this increase in measurement uncertainty U from measuring system S (G1, G2, G3, G4) to replacement measuring system S* (G1, G2, G3, G4*) is indicated by an arrow.

In the second exemplary embodiment according to FIG. 9, transmission link G2 in measuring system S (G1, G2, G3, G4) is first replaced by replacement transmission link G2* forming a first replacement measuring system S* (G1, G2*, G3, G4). In addition, transmission link G1 is replaced by replacement transmission link G1* so that the first replacement measuring system S* is replaced to a second replacement measuring system S* (G1*, G2*, G3, G4). Since the replacement measurement uncertainty contributions U12*, U21* are relatively smaller, the measurement uncertainty U of replacement measuring system S* is decreased. In FIG. 9, this decrease in measurement uncertainty U from measuring system S (G1, G2, G3, G4) to first replacement measuring system S* (G1, G2*, G3, G4) and to second replacement measuring system S* (G1*, G2*, G3, G4) is indicated by an arrow.

### LIST OF REFERENCE NUMERALS

a) identification of the transmission links of the measuring chain
b) determining the influencing variables of the identified transmission links on the measurement uncertainty of the measuring system
c) using the determined influencing variables for calculating the measurement uncertainty of the measuring system
d) determining an identified transmission link that has an important measurement uncertainty contribution
e) determining a replacement transmission link having a replacement measurement uncertainty contribution for the particular identified transmission link
A number
B amount
C computer program product
E11-E42 determined influencing variable
G1-G4 transmission link
G1*-G4* replacement transmission link
I, 1* digital information data
K measuring chain
L performance
R computer system
S measuring system
S* replacement measuring system
U measurement uncertainty
U11-U42 measurement uncertainty contribution
U11*-U42* replacement measurement uncertainty contribution
V method
R1 data processing processor
R2 data memory
R3, R3′ input unit
R4 output unit
R5, R5′ communication unit

What is claimed is:

1. A method for designing a cost-effective measuring system that uses a plurality of transmission links having directly adjacent transmission links in a cause-and-effect relationship to one another to form a measuring chain for detecting a physical measurement variable, the method comprising the steps of:
a) evaluating an initial design of the measuring chain to determine evaluation information, which includes each transmission link in the measuring chain evaluated to determine a type of each transmission link, a cost of each transmission link, and a relative position of each transmission link in the measurement chain of the initial design;
b) transmitting the evaluation information to a computer program product;
c) drawing from a computer storage medium, influencing information that specifies for each transmission link, an uncertainty contribution that amounts to the magnitude of the effect of each transmission link on a measurement uncertainty of the measuring system;
d) transmitting the influencing information to the computer program product;
e) running the computer program product to identify each uncertainty contribution of each transmission link of the measuring chain;
f) running the computer program product to determine from each uncertainty contribution of each transmission link of the measuring chain, a measurement uncertainty of the measuring chain;
g) running the computer product to sort according to uncertainty contribution, each transmission link in the measurement chain;
h) running the computer program product to evaluate for each transmission link in the measurement chain, benefit information, which compares the uncertainty contribution and cost of each transmission link; and
i) running the computer program product to generate for the measurement chain, an assessment information, which uses the benefit information to assess whether the measurement uncertainty of the measuring system can be maintained with a lower cost transmission link to replace a transmission link in the measuring chain of the initial design.

2. The method according to claim 1, further comprising the step of running the computer program product to generate for the measurement chain, an improvement information, which uses the benefit information to assess whether the measurement uncertainty of the measuring system can be improved with a lower cost transmission link to replace a transmission link in the measuring chain of the initial design.

3. The method according to claim 1, further comprising the step of running the computer program product to identify a significant transmission link, which is a transmission link in the measuring chain of the initial design having an uncertainty contribution that accounts for at least 80% of the magnitude of the measurement uncertainty of the measuring chain of the initial design and replacing all of the transmission links in the measuring chain of the initial design in a way that ensures the reliability of the significant transmission link while maintaining the same cost of the measurement chain relative to the cost of the measurement chain of the initial design.

4. The method according to claim 1, further comprising the step of running the computer program product to identify a significant transmission link, which is a transmission link in the measuring chain of the initial design having an uncertainty contribution that accounts for at least 80% of the magnitude of the measurement uncertainty of the measuring chain of the initial design and replacing all of the transmission links in the measuring chain of the initial design in a way that ensures the reliability of the significant transmission link while lowering the cost of the measurement chain relative to the cost of the measurement chain of the initial design.

5. The method according to claim 1, wherein the influencing information to be drawn from the computer storage medium includes one or more of the following essential characteristics: measuring range, measuring sensitivity, measuring accuracy, cable impedance at an input terminal of a signal cable, length of a signal cable, measuring accuracy of an electric amplifier, crosstalk between input-channels of an electric amplifier, accuracy of further processing of an evaluation unit, speed of further processing of an evaluation unit.

6. The method according to claim 1, further comprising the step of displaying the determined measurement uncertainty of the measuring chain on an output unit.
